(19) United States
(12) Patent Application Publication
(10) Pub. No.: US 2012/0205594 A1
(43) Pub. Date: Aug. 16, 2012

(54) ELECTRODE MATERIALS AND PROCESS FOR PRODUCING THEM

(75) Inventors: Robert BAYER, Sinsheim (DE); Bastian EWALD, Ludwigshafen (DE); Jordan Keith LAMPERT, Ludwigshafen (DE); Simon SCHRÖEDLE, Ludwigshafen (DE)

(73) Assignee: BASF SE, Ludwigshafen (DE)

(21) Appl. No.: 13/396,112

(22) Filed: Feb. 14, 2012

Related U.S. Application Data
(60) Provisional application No. 61/442,345, filed on Feb. 14, 2011.

(51) Int. Cl. H01B 1/18; B82Y 30/00

(52) U.S. Cl. 252/506; 977/773

(57) ABSTRACT

Process for producing electrode materials, wherein
(a) (A) at least one iron compound in which Fe is present in the oxidation state +2 or +3,
   (B) at least one phosphorus compound,
   (C) at least one lithium compound,
   (D) at least one carbon source which can be a separate carbon source or at the same time at least one iron compound (A) or phosphorus compound (B) or lithium compound (C),
   (E) optionally at least one reducing agent,
   (F) optionally at least one further metal compound which has a metal other than iron,
   (G) optionally water or at least one organic solvent,
      are mixed with one another,
(b) spray dried together by means of at least one apparatus which employs at least one spray nozzle for spraying and
(c) thermally treated at temperatures in the range from 350 to 1200° C.

The present invention relates to a process for producing electrode materials, wherein
(a) (A) at least one iron compound in which Fe is present in the oxidation state +2 or +3,
   (B) at least one phosphorus compound,
   (C) at least one lithium compound,
   (D) at least one carbon source which can be a separate carbon source or at the same time at least one iron compound (A) or phosphorus compound (B) or lithium compound (C),
   (E) optionally at least one reducing agent,
   (F) optionally at least one further metal compound which has a metal other than iron,
   (G) optionally water or at least one organic solvent,
   are mixed with one another,
(b) spray dried together by means of at least one apparatus which employs at least one spray nozzle for spraying and
(c) thermally treated at temperatures in the range from 350 to 1200° C.

The present invention further relates to electrode materials which can be obtained from the process of the invention. The present invention further relates to the use of electrode materials according to the invention in electrochemical cells.

In the search for advantageous electrode materials for batteries which utilize lithium ions as conductive species, numerous materials, for example lithium-comprising spinels, mixed oxides having a sheet structure, for example lithiated nickel-manganese-cobalt oxides and lithium-iron phosphates, have hitherto been proposed.

Lithium-iron phosphates are of particular interest because they do not comprise any toxic heavy metals and in many cases are very resistant to oxidation and water. A disadvantage of lithium-iron phosphates could be the comparatively low energy density.

A problem is that it is frequently desirable for lithium-iron phosphates to be very finely divided in order to display suitable electrochemical properties. High dust pollution and poor rheological properties, which cause problems in production and processing, are frequently observed in the case of finely divided lithium-iron phosphates.

It is therefore an object of the invention to provide a process for producing electrode materials, which is simple, requires very few steps and provides access to chemically insensitive electrode materials having good rheological properties. A further object was to provide chemically insensitive electrode materials which can be produced with an ideally low outlay and do not cause a high level of dust pollution. A further object was to provide electrochemical cells which have, overall, advantageous use properties. Examples of use properties are the properties in processing to produce batteries or battery components and the properties of the batteries manufactured therefrom.

We have accordingly found the process defined at the outset, hereinafter also referred to as process of the invention.

To carry out the process of the invention, a plurality of the starting materials, preferably all participating starting materials, are mixed in a plurality of or preferably in one operation in step (a). Suitable vessels for mixing are, for example, stirred tanks and stirred flasks.

The starting materials are described in more detail below.

As starting material (A), use is made of at least one iron compound, hereinafter also referred to as iron compound (A). Iron compound (A) is selected from among iron compounds in which the iron, i.e. Fe, is present in the oxidation state +2 or +3. These compounds are preferably inorganic iron compounds, for example iron oxide such as FeO, Fe₂O₃ or Fe₃O₄, iron hydroxide, for example Fe(OH)₃, FeOOH, also FeCO₃, water-comprising iron oxide, also described as FeO.aq or Fe₂O₃.aq, or water-soluble iron salts such as FeSO₄, Fe₂(SO₄)₃, iron(II) acetate, iron phosphate, iron phosphonate, iron citrate, lithium iron citrate, ammonium iron citrate, iron lactate, also basic iron carbonate and iron citrate. For the purposes of the present invention, carboxylic acid salts of iron are considered to be inorganic iron compounds.

Preferred iron compounds (A) are Fe(OH)₃, basic Fe(III) hydroxide, in particular FeOOH, ammonium iron citrate, Fe₂O₃, Fe₃O₄, iron acetate, iron citrate, iron lactate, iron phosphate, iron phosphonate and iron carbonate.

In an embodiment of the present invention, at least two iron compounds of which at least one, preferably at least two, has/have Fe in the oxidation state +2 or +3 are selected as starting material (A).

In an embodiment of the present invention, at least three iron compounds which all have Fe in the oxidation state +2 or +3 are selected as starting material (A).

In another embodiment of the present invention, precisely one iron compound in which Fe is present in the oxidation state +2 or +3 is selected as starting material (A).

Starting material (A) can be used, for example, as aqueous solution, as aqueous suspension or as powder, for example having average particle diameters in the range from 10 to 750 nm, preferably in the range from 25 to 500 nm.

As starting material (B), use is made of at least one phosphorus compound, hereinafter also referred to as phosphorus compound (B), selected from among phosphanes and compounds in which phosphorus is present in the oxidation state +1 or +3 or +5, for example phosphanes having at least one alkyl group or at least one alkoxy group per molecule, phosphorus halides, phosphonic acid, hypophosphorous acid and phosphoric acid. Preferred phosphanes are selected from PH₃ and phosphanes of the general formula (I)

P(R¹)ᵣ(X¹)ₛHₜ (I)

where the variables are selected as follows:
the radicals R¹ can be identical or different and are selected from among phenyl and preferably C₁-C₁₀-alkyl, cyclic or linear, for example methyl, ethyl, n-propyl, isopropyl, n-butyl, isobutyl, sec-butyl, tert-butyl, n-pentyl, cyclopentyl, isoamyl, isopentyl, n-hexyl, isohexyl, cyclohexyl and 1,3-dimethylbutyl, preferably n-C₁-C₆-alkyl, particularly preferably methyl, ethyl, n-propyl, isopropyl and very particularly preferably methyl or ethyl. When a material has a plurality of alkoxy groups per molecules, the radicals R′ can be different or preferably identical and be selected from among the abovementioned C₁-C₆-alkyl radicals,
the radicals X¹ can be identical or different and are selected from among halogen, phenoxy groups and alkoxy groups, preferably of the formula OR′, in particular methoxy and ethoxy, where halogen is preferably bromine and particularly preferably chlorine,
r, s are selected from among integers in the range from 0 to 3,
t is selected from among integers in the range from 0 to 2,
where the sum r+s+t=3 and
at least one of the inequalities
r≠0
s≠0
is satisfied.

In an embodiment of the present invention, phosphorus compound (B) is selected from among compounds of the general formula P(OR¹)₃, where the radicals R¹ can be different or preferably identical and are selected from among phenyl and C₁-C₁₀-alkyl, with particular preference being given to P(OCH₃)₃ and P(OC₂H₅)₃.

As phosphonic acid, hypophosphorous acid and phosphoric acid, it is in each case possible to select the free acid or corresponding salts, in particular lithium and ammonium salts. As phosphoric acid and phosphonic acid, it is in each case possible to choose the mononuclear acids H₃PO₃ or H₃PO₄, or else binuclear, trinuclear or multinuclear acids, for example H₄P₂O₇ or polyphosphoric acid.

In an embodiment of the present invention, two or more phosphorus compounds (B) are selected as starting material (B). In another embodiment of the present invention, precisely one phosphorus compound (B) is selected.

As starting material (C), use is made of at least one lithium compound, also referred to as lithium compound (C), preferably at least one inorganic lithium compound. Examples of suitable inorganic lithium compounds are lithium halides, for example lithium chloride, also lithium sulfate, lithium acetate, LiOH, Li₂CO₃, Li₂O and LiNO₃; with preference being given to Li₂SO₄, LiOH, Li₂CO₃, Li₂O and LiNO₃. The lithium compound can comprise water of crystallization, for example LiOH.H₂O.

In a specific embodiment of the present invention, lithium phosphate, lithium orthophosphate, lithium metaphosphate, lithium phosphonate, lithium phosphite, lithium hydrogenphosphate or lithium dihydrogenphosphate is selected as phosphorus compound (B) and lithium compound (C), i.e. lithium phosphate, lithium phosphonate, lithium phosphite or lithium (di)hydrogenphosphate can simultaneously serve as phosphorus compound (B) and as lithium compound (C).

As starting material (D), use is made of at least one carbon source, also referred to as carbon source (D) for short, which can be a separate carbon source or at the same time be at least one iron compound (A) or phosphorus compound (B) or lithium compound (C).

For the purposes of the present invention, the term separate carbon source (D) means that a further starting material which is selected from among elemental carbon in a modification which conducts electric current or a compound which decomposes into carbon in the thermal treatment in step (c) and is different from iron compound (A), phosphorus compound (B) and lithium compound (C) is used.

A suitable carbon source (D) is, for example, carbon in a modification which conducts electric current, i.e., for example, carbon black, graphite, graphene, carbon nanotubes or activated carbon.

Examples of graphite are not only mineral and synthetic graphite but also expanded graphite and intercalated graphite.

Carbon black can, for example, be selected from among lamp black, furnace black, flame black, thermal black, acetylene black and industrial black. Carbon black can comprise impurities, for example hydrocarbons, in particular aromatic hydrocarbons, or oxygen-comprising compounds or oxygen-comprising groups such as OH groups. Furthermore, sulfur- or iron-comprising impurities are possible in carbon black.

Further suitable carbon sources (D) are compounds of carbon which are decomposed into carbon in the thermal treatment in step (c). For example, synthetic and natural polymers, unmodified or modified, are suitable. Examples of synthetic polymers are polyolefins, for example polyethylene and polypropylene, also polyacrylonitrile, polybutadiene, polystyrene and copolymers of at least two comonomers selected from among ethylene, propylene, styrene, (meth)acrylonitrile and 1,3-butadiene. Polyisoprene and polyacrylates are also suitable. Particular preference is given to polyacrylonitrile.

For the purposes of the present invention, the term polyacrylonitrile encompasses not only polyacrylonitrile homopolymers but also copolymers of acrylonitrile with 1,3-butadiene or styrene. Preference is given to polyacrylonitrile homopolymers.

For the purposes of the present invention, the term polyethylene encompasses not only homopolyethylene but also copolymers of ethylene comprising at least 50 mol % of ethylene in copolymerized form and up to 50 mol % of at least one further comonomer, for example α-olefins such as propylene, butylene (1-butene), 1-hexene, 1-octene, 1-decene, 1-dodecene, 1-pentene, also isobutene, vinylaromatics such as styrene, also (meth)acrylic acid, vinyl acetate, vinyl propionate, C₁-C₁₀-alkyl esters of (meth)acrylic acid, in particular methyl acrylate, methyl methacrylate, ethyl acrylate, ethyl methacrylate, n-butyl acrylate, 2-ethylhexyl acrylate, n-butyl methacrylate, 2-ethylhexyl methacrylate, also maleic acid, maleic anhydride and itaconic anhydride. Polyethylene can be HDPE or LDPE.

For the purposes of the present invention, the term polypropylene encompasses not only homopolypropylene but also copolymers of propylene comprising at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

For the purposes of the present invention, the term polystyrene encompasses not only homopolymers of styrene but also copolymers with acrylonitrile, 1,3-butadiene, (meth)acrylic acid, C₁-C₁₀-alkyl esters of (meth)acrylic acid, divinylbenzene, in particular 1,3-divinylbenzene, 1,2-diphenylethylene and α-methylstyrene.

A further suitable synthetic polymer is polyvinyl alcohol.

Natural polymers suitable as carbon source (D) are, for example, starch, cellulose, alginates (e.g. agar agar, also pectins, gum arabic, oligosaccharides and polysaccharides, guar kernel flour and carob flour and also amylose and amylopectin.

Modified natural polymers are also suitable. For the purposes of the present invention, these are natural polymers modified by polymer-analogous reaction. Suitable polymer-analogous reactions are, in particular, esterification and etherification. Preferred examples of modified natural polymers are starch etherified with methanol, acetylated starch and acetylcellulose, also phosphated and sulfated starch.

Further suitable carbon sources (D) are carbides, preferably covalent carbides, for example iron carbide Fe₃C.

Relatively nonvolatile low molecular weight organic compounds are also suitable as carbon source (D). Suitable compounds are, in particular, compounds which do not vaporize but instead decompose at temperatures in the range from 350 to 1200° C., for example as solid or in the melt. Examples are dicarboxylic acids, for example phthalic acid, phthalic anhydride, isophthalic acid, terephthalic acid, tartaric acid, citric acid, pyruvic acid, also sugars, for example monosaccharides having from 3 to 7 carbon atoms per molecule (trioses, tetroses, pentoses, hexoses, heptoses) and condensates of monosaccharides, for example disaccharides, trisaccharides and oligosaccharides, in particular lactose, glucose and fructose, also sugar alcohols and sugar acids, for example aldonic acids, ketoaldonic acids, uronic acids and aldaric acids, in particular galactonic acid.

Further examples of low molecular weight organic compounds as carbon source (D) are urea and its relatively nonvolatile condensates biuret, melamine, melam (N2-(4,6-diamino-1,3,5-triazin-2-yl)-1,3,5-triazine-2,4,6-triamine) and melem (1,3,4,6,7,9,9b-heptaazaphenalene-2,5,8-triamine).

Further examples of carbon sources (D) are salts, preferably iron salts, ammonium salts and alkali metal salts, particularly preferably iron, sodium, potassium, ammonium or lithium salts, of organic acids, for example acetates, propionates, lactates, citrates, tartrates, benzoates, butyrates. Particularly preferred examples are ammonium acetate, potassium ammonium tartrate, potassium hydrogentartrate, potassium sodium tartrate, sodium tartrate (disodium tartrate), sodium hydrogentartrate, lithium hydrogentartrate, lithium ammonium tartrate, lithium tartrate, lithium citrate, potassium citrate, sodium citrate, iron acetate, lithium acetate, sodium acetate, potassium acetate, lithium lactate, ammonium lactate, sodium lactate and potassium lactate.

In another specific embodiment of the present invention, an organic phosphorus compound, for example trimethyl phosphate, triethyl phosphate, triphenylphosphane and triphenylphosphine oxide (C₆H₅)₃PO, is selected as carbon source (D) and phosphorus compound (B).

In a specific embodiment of the present invention, lithium acetate, lithium lactate or lithium hydrogentartrate is selected as carbon source (D) and lithium compound (C), i.e. lithium compound (C) lithium acetate, lithium lactate or lithium hydrogentartrate can simultaneously serve as carbon source (D).

In a specific embodiment of the present invention, iron acetate, iron citrate, iron carbide or ammonium iron citrate is selected as carbon source (D) and iron compound (A), i.e. the iron compound (A) iron acetate, iron citrate, iron carbide or ammonium iron citrate can simultaneously serve as carbon source (D).

In a specific embodiment of the present invention, lithium iron citrate is selected as iron compound (A), carbon source (D) and lithium compound (C), i.e. lithium iron citrate can simultaneously serve as iron compound (A), carbon source (D) and lithium compound (C).

In a specific embodiment of the present invention, two different carbon sources (D) and two different phosphorus compounds (B) are selected.

As starting material (E), it is possible to use a reducing agent, also referred to as reducing agent (E) for short. As reducing agent (E), it is possible to use gaseous, liquid or solid substances which under the conditions of step (a), (b) or (c) convert iron, if necessary, into the oxidation state +2.

In an embodiment of the present invention, a metal, for example nickel or manganese, or a metal hydride is selected as solid reducing agent (E).

As gaseous reducing agents (E), it is possible to use, for example, hydrogen, carbon monoxide, ammonia and/or methane.

A very useful reducing agent is H₃PO₃ and ammonium and lithium salts thereof.

Further suitable reducing agents are metallic iron and iron pentacarbonyl.

In a preferred embodiment of the present invention, H₃PO₃ is selected as phosphorus compound (B) and reducing agent (E), i.e. H₃PO₃ can simultaneously serve as phosphorus compound (B) and as reducing agent (E).

In an embodiment of the present invention, no reducing agent (E) is used.

As starting material (F), it is possible to use at least one further metal compound in which the metal or metals is/are different from iron, also referred to as metal compound (F) for short. Here, one or more metals from the first period of the transition metals is/are preferably selected as metal. Metal compound (F) is particularly preferably selected from among compounds of Ti, V, Cr, Mn, Co, Ni, Mg, Al, Nb, W, Mo, Cu and Zn. Sc, V, Mn, Ni, Co. Metal compound (F) is very particularly preferably selected from among oxides, hydroxides, carbonates and sulfates of metals of the first period of the transition metals.

Metal compound (F) can be anhydrous or comprise water. The metal cation in metal compound (F) can be present in complexed form, for example as hydrate complex, or be uncomplexed.

Metal compound (F) can be a salt, for example a halide, in particular chloride, also nitrate, carbonate, sulfate, oxide, hydroxide, acetate, citrate, tartrate or salts having various anions. Salts are preferably selected from among oxides, carbonates, hydroxides and nitrates, basic or neutral. Very particularly preferred examples of metal compounds (F) are oxides, hydroxides, carbonates and sulfates.

In another embodiment of the present invention, metal compound (F) is selected from among fluorides, for example as alkali metal fluoride, in particular sodium fluoride.

In an embodiment of the present invention, metal compound (F) can act as one or the only carbon source (D); examples which may be mentioned are nickel acetate, cobalt acetate, zinc acetate and manganese(II) acetate.

In an embodiment of the present invention, metal compound (F) can act as one or the only reducing agent (E). Examples which may be mentioned are manganese(II) acetate, MnCO₃, MnSO₄, nickel lactate, manganese hydride, nickel hydride, nickel suboxide, nickel carbide, manganese carbide and manganese(II) lactate.

In an embodiment of the present invention, one or more solvents, for example one or more organic solvents (G) and/or water, can be added in step (a). For the present purposes, organic solvents (G) are materials which are liquid at the temperature of step (a) of the process of the invention and have at least one C—H bond per molecule.

In one variant, water and an organic solvent (G) are added. Examples of suitable organic solvents (G) are, in particular, halogen-free organic solvents such as methanol, ethanol, isopropanol or n-hexane, cyclohexane, acetone, ethyl acetate, diethyl ether and diisopropyl ether.

Preference is given to water.

Without attaching prominence to a particular theory, it is possible that certain organic solvents (G) such as secondary or primary alkanols can also act as reducing agent (E).

The mixing in step (a) can be carried out, for example, by stirring together one or more suspensions of the starting materials (A) to (D) and optionally (E), (F) and (G). In other embodiments, the starting materials (A) to (D) and optionally (E) and (F) are intimately mixed with one another as solids. In another embodiment of the present invention, the starting materials (A) to (D) and optionally (E), (F) and (G) can be compounded together to form a paste.

In an embodiment of the present invention, the mixing in step (a) is carried out at temperatures in the range from 0 to 200° C., preferably at temperatures in the range from room temperature to 110° C., particularly preferably up to 80° C.

In an embodiment of the present invention, the mixing in step (a) is carried out at atmospheric pressure. In other embodiments, the mixing is carried out at superatmospheric pressure, for example at from 1.1 to 20 bar. In other embodiments, the mixing in step (a) is carried out under reduced pressure, for example at from 10 mbar to 990 mbar.

The mixing in step (a) can be carried out over a period in the range from one minute to 12 hours, preferably from 30 minutes to 4 hours, particularly preferably from 45 minutes to 2 hours.

In an embodiment of the present invention, the mixing in step (a) is carried out in one stage.

In another embodiment, the mixing in step (a) is carried out in two or more stages. Thus, it is possible, for example, firstly to dissolve or suspend iron compound (A) and lithium compound (C) together in water, then mix with phosphorus compound (B) and carbon source (D) and then optionally mix with reducing agent (E) and/or further metal compound (F).

In an embodiment, water and/or organic solvent are initially charged, then admixed in succession with lithium compound (C), iron compound (A), phosphorus or phosphorus compound (D), carbon compound (B) and optionally reducing agent (E) and/or further metal compound (F).

Step (a) gives a mixture of at least one iron compound (A), at least one phosphorus compound (B), at least one lithium compound (C), at least one carbon source (D), optionally reducing agent (E), optionally further metal compound (F) and preferably water and/or at least one organic solvent (G) in paste-like form, as water-comprising powder, as suspension or as solution.

In step (b) of the process of the invention, the mixture from step (a) is spray-dried by means of at least one apparatus which employs at least one spray nozzle for spraying, i.e. spray drying or atomization drying is carried out. The spray drying can be carried out in a spray dryer. Suitable spray dryers are drying towers, for example drying towers having one or more atomization nozzles, and spray dryers having an integrated fluidized bed.

Particularly preferred nozzles are two-phase nozzles, i.e. nozzles in the interior of which or at the opening of which materials in various states of matter are intensively mixed by means of separate inlets.

Step (b) can be carried out by, in one variant, pressing the mixture obtained in step (a) through one or more spraying devices, for example through one or more nozzles, or into a hot air stream or a hot inert gas stream or hot burner offgases, where the hot gas stream or the hot inlet gas stream or the hot burner offgases can have a temperature in the range from 90 to 500° C. In this way, the mixture is dried within fractions of a second or within a few seconds to give a dry material which is preferably obtained as powder. The powder obtained can have a certain residual moisture content, for example in the range from 500 ppm to 10% by weight, preferably in the range from 1 to 8% by weight, particularly preferably in the range from 2 to 6% by weight.

In a preferred embodiment, the temperature of the hot air stream or the hot inert gas stream or the hot burner offgases in step (b) is selected so that it is above the temperature in step (a).

In an embodiment of the present invention, the hot air stream or the hot inert gas stream or the hot burner offgases flow(s) in the same direction as the introduced mixture from step (a) (concurrent process). In another embodiment of the present invention, the hot air stream or hot inert gas stream or the hot burner offgases flow(s) in a direction counter to that of the introduced mixture from step (a) (countercurrent process). The spraying device is preferably located in the upper part of the spray dryer, in particular the spray tower.

The dry material obtained in step (b) can, after the actual spray drying, be separated off from the hot air stream or hot inert gas stream or the hot burner offgases by means of a precipitator, for example a cyclone. In another embodiment, the dry material obtained in step (b) is, after the actual spray drying, separated off from the hot air stream or hot inert gas stream or the hot burner offgases by means of one or more filters.

The dry material obtained in step (b) can, for example, have an average particle diameter (D50, weight average) in the range from 1 to 50 μm. Preference is given to the average particle diameter (D90, volume average) being up to 120 μm, particularly preferably up to 50 μm and very particularly preferably up to 20 μm.

Step (b) can be carried out batchwise (discontinuously) or continuously.

In the subsequent step (c), the dry material from step (b) is thermally treated at temperatures in the range from 350 to 1200° C., preferably from 400 to 900° C.

In an embodiment of the present invention, the thermal treatment in step (c) is carried out in a temperature profile having from 2 to 5 zones, preferably 3 or 4 zones, where each zone of the temperature profile preferably has a temperature higher than that of the preceding zone. For example, it is possible to set a temperature in the range from 350 to 550° C. in a first zone and a temperature in the range from 450 to 750° C. in a second zone, with the temperature in the latter being higher than in the first zone. If introduction of a third zone is desired, the thermal treatment in the third zone can be carried out at from 700 to 1200° C., but in any case at a temperature which is higher than that in the second zone. These zones can, for example, be produced by setting of particular heating zones.

If step (c) is to be carried out batchwise, it is possible to set a time profile over time, i.e., for example, the treatment is carried out firstly at from 350 to 550° C., then at from 450 to 750° C., with the temperature in the latter phase being higher than in the first phase. If introduction of a third phase is desired, the thermal treatment in the third phase can be carried out at from 700 to 1200° C., but in any case at a temperature which is higher than that in the second phase.

The thermal treatment in step (c) can be carried out, for example, in a rotary tube furnace, a shuttle reactor, a muffle furnace, a calcination furnace, a fused silica bulb furnace or a push-through furnace (roller hearth kiln or RHK).

The thermal treatment in step (c) can, for example, be carried out in a weakly oxidizing atmosphere, preferably in an inert or reducing atmosphere.

For the purposes of the present invention, the term weakly oxidizing refers to an oxygen-comprising nitrogen atmosphere comprising up to 2% by volume of oxygen, preferably up to 1% by volume.

Examples of inert atmospheres are a noble gas atmosphere, in particular an argon atmosphere, and a nitrogen atmosphere. Examples of reducing atmospheres are nitrogen or noble gases comprising from 0.1 to 10% by volume of carbon monoxide, hydrocarbon, ammonia or hydrogen. Further examples of reducing atmospheres are air or air enriched with nitrogen or with carbon dioxide, in each case comprising more mol % of carbon monoxide than oxygen.

In an embodiment of the present invention, step (c) can be carried out over a period in the range from 1 minute to 24 hours, preferably in the range from 10 minutes to 3 hours.

The process of the invention can be carried out without a high level of dust pollution. The process of the invention makes it possible to obtain electrode materials which have excellent rheological properties and are suitable as electrode materials and can be processed very well. For example, they can be processed to give pastes having good rheological properties, and such pastes have a low viscosity.

The present invention further provides electrode materials comprising
(H) carbon in an electrically conductive modification and
(I) at least one compound of the general formula (I),

Liₓ(M_{(1-y)}Fe_{y})ₐPO_{z} (I)

also referred to as transition metal compound (I) for short, where the variables are defined as follows:
M is selected from among Sc, Ti, V, Cr, Mn, Co, Ni, Mg, Al, Nb, W, Mo, Cu and Zn, preferably selected from among Sc, V, Mn, Ni and Co;
x is in the range from 0.1 to 4, preferably at least 0.8, particularly preferably from 1 to 3, very particularly preferably from 1.5 to 2.5;
y is in the range from 0.1 to 1, preferably at least 0.2;
z is in the range from 2 to 6, preferably from 3 to 5, particularly preferably from 2.5 to 4.5 and very particularly preferably 4;
a is in the range from 0.1 to 4, preferably from 0.2 to 2, particularly preferably from 0.5 to 1.5 and very particularly preferably 1;
   wherein carbon (H) is present in the pores of secondary particles of transition metal compound (I) or in the form of particles which can contact the particles of transition metal compound (I) at points or can contact one or more particles of carbon (H).

In an embodiment of the present invention, the variables in transition metal compound (I) have the following meanings:
x is in the range from 0.8 to 3,
y is in the range from 0.01 to 1,
z is in the range from 3 to 5,
a is in the range from 0.2 to 2.0
   and the remaining variables are as defined above.

Transition metal compound (I) very particularly preferably has the formula LiFePO₄ or LiFe_{0.2}Mn_{0.8}PO₄ or LiFe_{0.5}Mn_{0.5}PO₄ or LiFe_{0.7}Mn_{0.3}PO₄.

Elements such as potassium and sodium are ubiquitous, at least in traces. For the purposes of the present invention, proportions of sodium or potassium in the region of 0.1% by weight, based on total transition metal compound (I), or less should therefore not be considered to be constituents of transition metal compound (I).

In an embodiment of the present invention, transition metal compound (I) can be doped or contaminated with one or more further metal cations, for example with alkaline earth metal cations, in particular with Mg²⁺ or Ca²⁺, or with alkali metal cations, in particular with K⁺ or Na⁺.

In an embodiment of the present invention, electrode material according to the invention has a BET surface area in the range from 10 to 40 m²/g, determined in accordance with DIN 66131.

In an embodiment of the present invention, electrode material according to the invention has a monomodal pore diameter distribution. In another embodiment of the present invention, electrode material according to the invention has a bimodal pore diameter distribution. In another embodiment of the present invention, electrode material according to the invention has a multimodal pore diameter distribution.

Carbon in an electrically conductive modification (H), carbon for short, is, for example, carbon black, graphite, graphene, carbon nanotubes, expanded graphites, intercalcated graphites or activated carbon.

In an embodiment of the present invention, electrically conductive, carbon-comprising material is carbon black. Carbon black can, for example, be selected from among lamp black, furnace black, flame black, thermal black, acetylene black and industrial black. Carbon black can comprise impurities, for example hydrocarbons, in particular aromatic hydrocarbons, or oxygen-comprising compounds or oxygen-comprising groups such as OH groups, epoxide groups, carbonyl groups and/or carboxyl groups. Furthermore, sulfur- or iron-comprising impurities are possible in carbon black.

In one variant, electrically conductive, carbon-comprising material is partially oxidized carbon black. Partially oxidized carbon black, also referred to as activated carbon black, comprises oxygen-comprising groups such as OH groups, epoxide groups, carbonyl groups and/or carboxyl groups.

In an embodiment of the present invention, electrically conductive, carbon-comprising material is carbon nanotubes. Carbon nanotubes (CNTs for short), for example single-walled carbon nanotubes (SW CNTs) and preferably multi-walled carbon nanotubes (MW CNTs), are known per se. A process for producing them and some properties are described, for example, by A. Jess et al. in Chemie Ingenieur Technik 2006, 78, 94-100.

In an embodiment of the present invention, carbon nanotubes have a diameter in the range from 0.4 to 50 nm, preferably from 1 to 25 nm.

In an embodiment of the present invention, carbon nanotubes have a length in the range from 10 nm to 1 nm, preferably from 100 nm to 500 nm,

Carbon nanotubes can be produced by processes known per se. For example, a volatile carbon-comprising compound such as methane or carbon monoxide, acetylene or ethylene or a mixture of volatile carbon-comprising compounds such as synthesis gas can be decomposed in the presence of one or more reducing agents such as hydrogen and/or a further gas such as nitrogen. Another suitable gas mixture is a mixture of carbon monoxide with ethylene. Suitable temperatures for the decomposition are, for example, in the range from 400 to 1000° C., preferably from 500 to 800° C. Suitable pressure conditions for the decomposition are, for example, in the range from atmospheric pressure to 100 bar, preferably up to 10 bar.

Single- or multi-walled carbon nanotubes can be obtained, for example, by decomposition of carbon-comprising compounds in an electric arc, in the presence or absence of a decomposition catalyst.

In an embodiment, the decomposition of the volatile carbon-comprising compound or carbon-comprising compounds is carried out in the presence of a decomposition catalyst, for example Fe, Co or preferably Ni.

For the purposes of the present invention, the term graphene refers to virtually ideally or ideally two-dimensional hexagonal carbon crystals which have a structure analogous to single graphite layers. They can be one layer of carbon atoms thick or only a few, for example from 2 to 5, layers of carbon atoms thick. Graphene can be produced by exfoliation or delamination of graphite.

For the purposes of the present invention, intercalated graphites are incompletely delaminated graphites which comprise other atoms, ions or compounds intercalated between the hexagonal carbon atom layers. It is possible, for example, for alkali metal ions, SO₃, nitrate or acetate to be intercalated. The preparation of intercalated graphites (also: expanded graphites) is known, see, for example, Rüdorff, Z. anorg. Allg. Chem. 1938, 238(1), 1. Intercalated graphites can be prepared, for example, by thermal expansion of graphite.

Expanded graphites can be obtained, for example, by expansion of intercalated graphites, see, for example McAllister et al. Chem. Mater. 2007, 19, 4396-4404.

In an embodiment of the present invention, the weight ratio of transition metal compound (I) to carbon (H) is in the range from 200:1 to 5:1, preferably from 100:1 to 10:1, particularly preferably from 100:1.5 to 20:1.

Carbon (H) is present in the pores of secondary particles of transition metal compound (I) or in the form of particles which can contact the particles of transition metal compound (I) at points or can contact one or more particles of carbon (H).

Carbon (H) is not present as a coating on secondary particles of transition metal compound (I), either as complete coating or as partial coating. Particles of carbon (H) do not contact secondary particles of transition metal compound (I) via edges.

In an embodiment of the present invention, carbon (H) and transition metal compound (I) are present side-by-side in discrete particles which contact one another at points or not at all.

The above-described morphology of carbon (H) and transition metal compound (I) can be confirmed, for example, by optical microscopy, transmission electron microscopy (TEM) or scanning electron microscopy (SEM), and also, for example, X-ray crystallographically in the diffraction pattern.

In an embodiment of the present invention, primary particles of compound (I) have an average diameter in the range from 1 to 2000 nm, preferably from 10 to 1000 nm, particularly preferably from 50 to 500 nm. The average primary particle diameter can, for example, be determined by SEM or TEM.

In an embodiment of the present invention, transition metal compound (I) is present in the form of particles which have an average particle diameter in the range from 1 to 150 μm (d50) and can be present in the form of agglomerates (secondary particles). Preference is given to average particle diameters (d50) in the range from 2 to 50 μm, particularly preferably in the range from 4 to 30 μm.

In an embodiment of the present invention, transition metal compound (I) is present in the form of particles which have an average pore diameter in the range from 0.05 μm to 2 μm and can be present in agglomerates. The average pore diameter can be determined, for example, by mercury porosimetry, for example in accordance with DIN 66133.

In an embodiment of the present invention, transition metal compound (I) is present in the form of particles which have an average pore diameter in the range from 0.05 μm to 2 μm and display a monomodal or multimodal profile of the intrusion volumes in the range 100-0.001 μm and preferably have a pronounced maximum in the range from 10 μm to 1 μm, preferably two pronounced maxima, one in the range from 10 to 1 μm and one in the range from 1 to 0.1 μm.

In an embodiment of the present invention, carbon (H) has an average primary particle diameter in the range from 1 to 500 nm, preferably in the range from 2 to 100 nm, particularly preferably in the range from 3 to 50 nm, very particularly preferably in the range from 4 to 10 nm.

For the purposes of the present invention, particle diameters are preferably reported as volume averages, which can be determined, for example, by laser light scattering on dispersions according to the Fraunhofer or Mie Theory.

In an embodiment of the present invention, electrode material according to the invention additionally comprises at least one binder (J), for example a polymeric binder.

Suitable binders (J) are preferably selected from among organic (co)polymers. Suitable (co)polymers, i.e. homopolymers or copolymers, can, for example, be selected from among (co)polymers which can be obtained by anionic, catalytic or free-radical (co)polymerization, in particular from among polyethylene, polyacrylonitrile, polybutadiene, polystyrene, and copolymers of at least two comonomers selected from among ethylene, propylene, styrene, (meth)acrylonitrile and 1,3-butadiene. Polypropylene is also suitable. Furthermore, polyisoprene and polyacrylates are suitable. Particular preference is given to polyacrylonitrile.

For the purposes of the present invention, the term polyacrylonitrile encompasses not only polyacrylonitrile homopolymers but also copolymers of acrylonitrile with 1,3-butadiene or styrene. Preference is given to polyacrylonitrile homopolymers.

For the purposes of the present invention, the term polyethylene refers not only to homopolyethylene but also copolymers of ethylene which comprise at least 50 mol % of ethylene in copolymerized form and up to 50 mol % of at least one further comonomer, for example α-olefins such as propylene, butylene (1-butene), 1-hexene, 1-octene, 1-decene, 1-dodecene, 1-pentene, also isobutene, vinylaromatics such as styrene, also (meth)acrylic acid, vinyl acetate, vinyl propionate, C₁-C₁₀-alkyl esters of (meth)acrylic acid, in particular methyl acrylate, methyl methacrylate, ethyl acrylate, ethyl methacrylate, n-butyl acrylate, 2-ethylhexyl acrylate, n-butyl methacrylate, 2-ethylhexyl methacrylate, also maleic acid, maleic anhydride and itaconic anhydride. Polyethylene can be HDPE or LDPE.

For the purposes of the present invention, the term polypropylene refers not only to homopolypropylene but also to copolymers of propylene which comprise at least 50 mol % of propylene in copolymerized form and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

For the purposes of the present invention, the term polystyrene refers not only to homopolymers of styrene but also to copolymers with acrylonitrile, 1,3-butadiene, (meth)acrylic acid, C₁-C₁₀-alkyl esters of (meth)acrylic acid, divinylbenzene, in particular 1,3-divinylbenzene, 1,2-diphenylethylene and α-methylstyrene.

Another preferred binder (J) is polybutadiene.

Other suitable binders (J) are selected from among polyethylene oxide (PEO), cellulose, carboxymethylcellulose, polyimides and polyvinyl alcohol.

In an embodiment of the present invention, binders (J) are selected from (co)polymers which have an average molecular weight M_{w} in the range from 50 000 to 1 000 000 g/mol, preferably up to 500 000 g/mol.

Binders (J) can be crosslinked or uncrosslinked (co)polymers.

In a particularly preferred embodiment of the present invention, binders (J) are selected from among halogenated (co)polymers, in particular from among fluorinated (co)polymers. Here, halogenated or fluorinated (co)polymers are (co)polymers which comprise, in copolymerized form, at least one (co)monomer which has at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoro(alkyl vinyl ether) copolymers, ethylene-tetrafluoroethylene copolymers, vinylidene fluoride-chlorotrifluoroethylene copolymers and ethylene-chlorofluoroethylene copolymers.

Suitable binders (J) are, in particular, polyvinyl alcohol and halogenated (co)polymers, for example polyvinyl chloride or polyvinylidene chloride, in particular fluorinated (co)polymers such as polyvinyl fluoride and in particular polyvinylidene fluoride and polytetrafluoroethylene.

In an embodiment of the present invention, electrode material according to the invention comprises:

from 60 to 98% by weight, preferably from 70 to 96% by weight, of transition metal compound (I),
from 1 to 25% by weight, preferably from 2 to 20% by weight, of carbon (H),
from 1 to 20% by weight, preferably from 2 to 15% by weight, of binder (J).

Electrode materials according to the invention can readily be used for producing electrochemical cells. For example, they can be processed to give pastes having good rheological properties.

The present invention further provides electrochemical cells produced using at least one electrode according to the invention. The present invention further provides electrochemical cells comprising at least one electrode according to the invention.

A further aspect of the present invention is an electrode comprising at least one transition metal compound (I), carbon (H) and at least one binder (J).

Compound of the general formula (I), carbon (H) and binders (J) have been described above.

The geometry of electrodes according to the invention can be selected within wide limits. Electrodes according to the invention are preferably configured as thin films, for example films having a thickness in the range from 10 μm to 250 μm, preferably from 20 to 130 μm.

In an embodiment of the present invention, electrodes according to the invention comprise a foil/film, for example a metal foil, in particular an aluminum foil, or a polymer film, for example a polyester film, which can be untreated or siliconized.

The present invention further provides for the use of electrode materials according to the invention or electrodes according to the invention in electrochemical cells. The present invention further provides a process for producing electrochemical cells using electrode material according to the invention or electrodes according to the invention. The present invention further provides electrochemical cells comprising at least one electrode material according to the invention or at least one electrode according to the invention.

Electrodes according to the invention by definition serve as cathodes in electrochemical cells according to the invention. Electrochemical cells according to the invention comprise a counterelectrode which for the purposes of the present invention is defined as anode and can be, for example, a carbon anode, in particular a graphite anode, a lithium anode, a silicon anode or a lithium titanate anode.

Electrochemical cells according to the invention can be, for example, batteries or accumulators.

Electrochemical cells according to the invention can comprise not only an anode and an electrode according to the invention but also further constituents, for example electrolyte salt, nonaqueous solvent, separator, power outlet leads, for example leads made of metal or an alloy, also cable connections and housing.

In an embodiment of the present invention, electric cells according to the invention comprise at least one nonaqueous solvent which can be liquid or solid at room temperature, preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Here, polyethylene glycols can comprise up to 20 mol % of one or more C₁-C₄-alkylene glycols in copolymerized form. Polyalkylene glycols are preferably polyalkylene glycols capped with two methyl or ethyl groups.

The molecular weight M_{w} of suitable polyalkylene glycols and in particular of suitable polyethylene glycols can be at least 400 g/mol.

The molecular weight M_{w} of suitable polyalkylene glycols and in particular of suitable polyethylene glycols can be up to 5 000 000 g/mol, preferably up to 2 000 000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds of the general formulae (II) and (III)

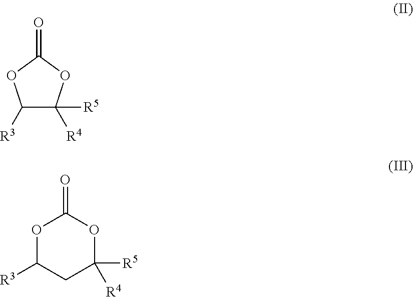

in which R³, R⁴ and R⁵ can be identical or different and are selected from among hydrogen and C₁-C₄-alkyl, for example methyl, ethyl, n-propyl, isopropyl, n-butyl, isobutyl, sec-butyl and tert-butyl, with preference being given to R⁴ and R⁵ not both being tert-butyl.

In particularly preferred embodiments, R³ is methyl, and R⁴ and R⁵ are each hydrogen, or R⁵, R³ and R⁴ are each hydrogen.

Another preferred cyclic organic carbonate is vinylene carbonate, formula (IV).

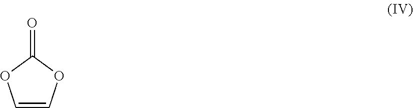

The solvent or solvents is/are preferably used in the “water-free” state, i.e. with a water content in the range from 1 ppm to 0.1% by weight, which can be determined, for example, by Karl-Fischer titration.

Electrochemical cells according to the invention further comprise at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘYLi, where m is defined as follows:

m=1, when Y is selected from among oxygen and sulfur,
m=2, when Y is selected from among nitrogen and phosphorus, and
m=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In an embodiment of the present invention, electrochemical cells according to the invention comprise one or more separators by means of which the electrodes are mechanically separated. Suitable separators are polymer films, in particular porous polymer films, which are unreactive toward metallic lithium. Particularly suitable materials for separators are polyolefins, in particular porous polyethylene in the form of a film and porous polypropylene in the form of a film.

Separators composed of polyolefin, in particular polyethylene or polypropylene, can have a porosity in the range from 35 to 45%. Suitable pore diameters are, for example, in the range from 30 to 500 nm.

In another embodiment of the present invention, it is possible to use separators composed of PET nonwovens filled with inorganic particles. Such separators can have a porosity in the range from 40 to 55%. Suitable pore diameters are, for example, in the range from 80 to 750 nm.

Electrochemical cells according to the invention further comprise a housing which can have any shape, for example cuboidal or in the form of a cylindrical disk. In one variant, a metal foil configured as a bag is used as housing.

Electrochemical cells according to the invention produce a high voltage and have a high energy density and good stability.

Electrochemical cells according to the invention can be combined with one another, for example connected in series or connected in parallel. Connection in series is preferred.

The present invention further provides for the use of electrochemical cells according to the invention in appliances, in particular in mobile appliances. Examples of mobile appliances are vehicles, for example automobiles, two-wheeled vehicles, aircraft or water vehicles such as boats or ships. Other examples of mobile appliances are those which are moved by human beings, for example computers, in particular laptops, telephones or electrical hand tools, for example in the field of building, in particular drilling machines, screwdrivers powered by rechargeable batteries or tackers powdered by rechargeable batteries.

The use of electrochemical cells according to the invention in appliances offers the advantage of a relatively long running time before recharging. If the same running time were wanted when using electrochemical cells having a lower energy density, a higher weight of electrochemical cells would have to be accepted.

The invention is illustrated by examples.

### EXAMPLES

### I. Production of an Electrode Material

### Step (a.1)

### Starting Materials:

### 12.14 kg of α-FeOOH (A.1)

### 5.83 kg of LiOH H₂O(C.1)

### 5.66 kg of H₃PO₃ (B.1)

### 7.89 kg of H₃PO₄ (B.2)

2.17 kg of lactose (D.1)
1.96 kg of starch (D.2)

133.5 l of distilled water were firstly placed in a 200 liter double-walled stirred vessel provided with an anchor stirrer and heated to 58.5° C. The LiOH.H₂O(C.1) was subsequently dissolved therein and the iron compound (A.1) was then added. (B.1) and (B.2) were then added. The temperature rose to 78° C. (D.1) and (D.2) were then added. The mixture was stirred at 75° C. for a further 16 hours (pH: 5). A yellow suspension was obtained.

### Step (b.1)

The solution from step (a.1) was sprayed in air in a spraying tower according to a program. The hot air stream had a temperature of 330° C. at the inlet and 110° C. at the outlet. The dryer was operated using 350 kg/h of drying gas and 33 kg/h of nozzle gas (atomization gas) at an atomization pressure of 3.5 bar.

This gave a yellow, free-flowing powder having a residual moisture content of 8%. It was in the form of particles whose diameter (D50) was 19 μm. SEM images showed spherical agglomerates of the yellow powder which were held together in the interior by the organic constituents lactose and starch.

### Step (c.1)

The yellow powder from step (b.1) was thermally treated in a 2 l steel laboratory rotary furnace under an N₂ atmosphere. The 2 l steel laboratory rotary furnace had three temperature zones and rotated at a speed of 10 revolutions/min. The temperature in zone 1 was 450° C., the temperature in zone 2 was 725° C. and that in zone 3 was 775° C. The average residence time was one hour. After the thermal treatment was complete, the product was allowed to cool to room temperature. This gave electrode material according to the invention comprising transition metal compound (1.1) and carbon (H.1). Carbon (H.1) and transition metal compound (1.1) were, as could be shown by optical microscopy, present in discrete particles which were either not in contact or were in contact only at a single point. Diameter (D50): 17.2 μm.

The tamped density of the sieve fraction <32 μm was 0.92 g/ml.

### II. Production of Electrochemical Cells According to the Invention

Electrode material according to the invention was processed as follows with a binder (J.1): copolymer of vinylidene fluoride and hexafluoropropene, as powder, commercially available as Kynar Flex® 2801 from Arkema, Inc.

To determine the electrochemical data of the electrode materials, 8 g of electrode material according to the invention from step (c.1) and 1 g of (J.1) were mixed to a paste with addition of 1 g of N-methylpyrrolidone (NMP). A 30 μm thick aluminum foil was coated with the above-described paste (active material loading: 2.72 mg/cm²). After drying, but without compression, at 105° C., circular pieces of the resulting coated aluminum foil (diameter: 20 mm) were stamped out. Electrochemical cells were produced from the electrodes which can be obtained in this way.

A 1 mol/l solution of LiPF₆ in ethylene carbonate/dimethyl carbonate (mass ratio=1:1) was used as electrolyte. The anode of the test cells comprised a lithium foil which is in contact with the cathode foil via a separator made of glass fiber paper.

Electrochemical cells EZ.1 according to the invention are obtained.

When electrochemical cells according to the invention are cycled (charged/discharged) between 3 V and 4 Vat 25° C. in 100 cycles and when charging and discharging currents are 150 mA/g of cathode material, retention of the discharging capacity after 100 cycles can be determined.

Electrochemical cells EZ.1 according to the invention display a good cycling stability.

1. A process for producing electrode materials, wherein
(a) (A) at least one iron compound in which Fe is present in the oxidation state +2 or +3,
(B) at least one phosphorus compound,
(C) at least one lithium compound,
(D) at least one carbon source which can be a separate carbon source or at the same time at least one iron compound (A) or phosphorus compound (B) or lithium compound (C),
(E) optionally at least one reducing agent,
(F) optionally at least one metal compound which has a metal other than iron,
(G) optionally water or at least one organic solvent, are mixed with one another,
(b) spray dried together by means of at least one apparatus which employs at least one spray nozzle for spraying and
(c) thermally treated at least two different temperatures in the range from 350 to 1200° C.

2. The process according to claim 1, wherein a separate carbon source selected from among activated carbon, carbon black, conductive carbon black, graphenes, carbides, organic polymers and graphite is used as carbon source (D).

3. The process according to claim 1, wherein at least one salt of iron or lithium with at least one organic acid is used as carbon source which is the same as at least one iron compound (A) or lithium compound (C).

4. The process according to any of claims 1 to 3, wherein iron compound (A) is selected from among Fe(OH)₃, FeOOH, ammonium iron citrate, Fe₂O₃, Fe₃O₄, iron acteate, FeSO₄, iron citrate, iron lactate, iron phosphate, iron phosphonate and iron carbonate.

5. The process according to any of claims 1 to 4, wherein lithium compound (C) is selected from among LiOH, Li₂CO₃, Li₂O, LiNO₃, Li₂SO₄, lithium phosphonates and Li phosphates.

6. The process according to any of claims 1 to 5, wherein phosphorus compound (B) is selected from among H₃PO₄, H₃PO₃ and salts and esters of the abovementioned acids.

7. The process according to any of claims 1 to 6, wherein the thermal treatment in step (c) is carried out in an inert atmosphere or a reducing atmosphere.

8. The process according to any of claims 1 to 6, wherein the thermal treatment in step (c) is carried out in an oxidizing atmosphere.

9. The process according to any of claims 1 to 8, wherein metal compound (F) is selected from compounds of Sc, Ti, V, Cr, Mn, Co, Ni, Mg, Al, Nb, W, Mo, Cu and Zn.

10. An electrode material comprising
(H) carbon in an electrically conductive modification and
(I) at least one compound of the general formula (I),
Liₓ(M_{(1-y)}Fe_{y})ₐPO_{z} (I)
where the variables are defined as follows:
M is selected from among Sc, Ti, V, Cr, Mn, Co, Ni, Mg, Al, Nb, W, Mo, Cu and Zn,
x is in the range from 0.1 to 4,
y is in the range from 0.1 to 1,
z is in the range from 2 to 6,
a is in the range from 0.1 to 4,
wherein carbon (H) is present in the pores of secondary particles of transition metal compound (I) or in the form of particles which can contact the particles of transition metal compound (I) at points or can contact one or more particles of carbon (H).

11. The electrode material according to claim 10, wherein the variables are selected as follows:
x is in the range from 0.8 to 3,
y is at least 0.01,
z is in the range from 3 to 5,
a is in the range from 0.2 to 2,
and the remaining variables are as defined above.

12. The electrode material according to claim 10 or 11, wherein the variables are selected as follows:
x is 1,
y is 1,
z is 4,
a is in the range from 0.9 to 1.1
and the remaining variables are as defined above.

13. The electrode material according to any of claims 10 to 12, wherein carbon (H) has an average particle diameter in the range from 1 to 500 nm.

14. The electrode material according to any of claims 10 to 13 which has a residual moisture content in the range from 100 to 5000 ppm.

15. The electrode material according to any of claims 10 to 14, wherein the compound of the general formula (I) is present in the form of particles which can be present in agglomerates and have an average particle diameter in the range from 1 to 150 μm (d50).

16. The electrode material according to any of claims 10 to 15, wherein the compound of the general formula (I) is present in the form of particles which have an average pore diameter in the range from 0.05 μm to 2 μm and can be present in agglomerates.

17. The use of electrode materials according to any of claims 10 to 16 for producing electrochemical cells.

18. An electrochemical cell comprising at least one electrode material according to any of claims 10 to 16.

19. The use of electrochemical cells according to claim 18 in appliances.
